(19) United States
(12) Patent Application Publication
(10) Pub. No.: US 2010/0269381 A1
(43) Pub. Date: Oct. 28, 2010

(54) Labeling For A User Selectable Flavored Drink

(76) Inventor: Chad Steelberg, Newport Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/717,211

(22) Filed: Mar. 4, 2010

Related U.S. Application Data
(60) Provisional application No. 61/209,361, filed on Mar. 4, 2009.

(51) Int. Cl. G09F 3/00

(52) U.S. Cl. 40/310

(57) ABSTRACT

A labeling system for placement of at least a portion of a label on a multi-chamber beverage container is described. The system includes a label materials engine for selection of a label for placement on the multi-chamber beverage container, where the label comprises at least one talent for endorsing at least one of a first and a second beverage constituent within the multi-chamber beverage container. The at least one talent is selected responsive to selection of at least one of the first and the second beverage constituent, such that the talent at least partially endorses a beverage created by the dissolving of the at least one second constituent in the first beverage constituent.

### CROSS-REFERENCE TO RELATED APPLICATIONS

This application claims the benefit of priority to U.S. Patent Application No. 61/209,361, filed on Mar. 4, 2009, the entire disclosure of which is incorporated by reference herein as if set for herein in its entirety.

### FIELD OF THE INVENTION

The invention relates to fitness and flavored drinks available from vending machines and, more particularly, to a user selectable multi-flavored drink.

### BACKGROUND OF THE INVENTION

vending machine provides various snacks, beverages, and other products to consumers. The idea is to vend products without need of a cashier. After paying, a product may become available, for example, by: the machine releasing it, so that it falls in an open compartment accessible to the purchaser, or a machine-pour into a container, or placed into a container by the customer, such as by the unlocking of a door, drawer, turning of a knob, etc. Sometimes the product is not just released, but also prepared; this may be the case, for example, with vended coffee, french fries, or a ticket that is printed after paying.

A full line vending company may set up several types of vending machines that sell a wide range of products. The types of products include candy, cookies, chips, fresh fruit, milk, cold food, coffee, bottles and/or cans of soda, and even frozen products like ice cream. These products can be sold from various types of vending machines that include coffee, snack, cold food, 20-oz. bottle machines, and glass-front bottle machines.

With the increase in healthy vending and specialized vending, as well as the safety features on many vending machines, these machines have become increasingly unwieldy and/or the number of selections in the machines has become very limited. In particular, when a flavored beverage is purchased, the drinks are pre-mixed. For example, vitamin-water takes up a great deal of space in a vending machine, but still presents limited options to a consumer. And, with an offering of approximately fifteen flavors of water by some manufacturers/sellers, it is not uncommon for an entire machine to be devoted solely to vitamin water. Thus, a need exists for a way to reduce the number of necessary shelved items while maintaining the number of selections in an overall product choice.

Further, there is doubt as to whether the added vitamins actually stay stable after the bottles spend an extended amount of time on the shelves before customers drink them. Some believe that the added vitamins might break down under the many dramatic temperatures changes experienced during transported from warehouses to stores. Thus, a further need exists to protect the vitamins added, such as by maintaining the vitamins separately until the last minute before consumption.

### BRIEF SUMMARY OF THE INVENTION

The present invention includes a labeling system for placement of at least a portion of a label on a multi-chamber beverage container. The labeling system comprises a label materials engine for selection of a label for placement on the multi-chamber beverage container, the label comprising at least one talent for endorsing at least one of a first and a second beverage constituent within the multi-chamber beverage container. The multi-chamber beverage container comprises a first chamber that contains the first beverage constituent, and comprises at least one resealable opening for dispensing the beverage, at least one secondary chamber that contains the at least one second beverage constituent, wherein the secondary chamber is physically adjacent to the first chamber, and wherein the secondary chamber and first chamber are separated by at least one initial seal, wherein the at least one second beverage constituent is at least partially dissolved into the first beverage constituent upon an at least temporarily breaking of the at least one initial seal by a force applied by a consumer of the beverage, and wherein the at least one talent is selected responsive to selection of at least one of the first and the second beverage constituent, such that the talent at least partially endorses a beverage created by the dissolving of the at least one second constituent in the first beverage constituent.

In certain embodiments, the selection of the at least one talent is further based on a targeted geographic market of the multi-chamber beverage container. In other embodiments, the selection of the at least one talent is further based on targeted purchasers of the multi-chamber beverage container. In other embodiments, the selection of the at least one talent is further based on the recent existing media associated with the at least one talent. In other embodiments, the selection of the at least one talent is further based on prospective media associated with the at least one talent. In another embodiment, the at least one talent comprises an athlete. In another embodiment, the at least one talent comprises at least two talents, and wherein a first of the at least two talents endorses the first constituent, and a second of the at least two talents endorses the second constituent. In other embodiments, the talent endorses the second constituent, and wherein the second constituent comprises medication. In other embodiments, the resealable opening includes at least one selected from the group consisting of a screw-on cap, a tab and a flip-top. In other embodiments, the force is applied solely to an exterior of the multi-chamber container. In other embodiments, the initial seal is at least partially cracked by the force. In other embodiments, the force comprises a depression. In another embodiment, the labeling system includes a plunger mechanism that is activated by the force. In other embodiments, the mixing of the first and second beverage constituents is metered. In other embodiments, the metering is according to consumer preference. In other embodiments, the at least one talent comprises an actor. In other embodiments, the endorsement comprises a pre-approval within the labeling materials engine. In other embodiments, the endorsement comprises an approval interface within the labeling materials engine to the at least one talent. In other embodiments, the labeling materials engine comprises a recommendation engine that recommends ones of the talent.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and wherein:

FIG. 1 is a cross section of a bottle according to an aspect of the present invention;

FIG. 2 is a depiction of a wrapper for placement on a bottle according to an aspect of the present invention; and

FIG. 3 is a depiction of a software engine according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in prepackaged foods and drinks. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

According to an aspect of the present invention there is integrated into a container, such as a bottle, (n) number of chambers, which chambers preferably contain one or more of a flavor, nutrients, or other individual substituent parts (hereinafter “constituents”) of food stuffs, liquids, and most particularly beverages. Once a drink is purchased or otherwise obtained, a user may, for example, depress, crack or otherwise execute an opening of a seal from the external side of the chamber/of the bottle—which opening of a seal releases the constituent from, for example, 1-N of the chambers into the container. The user may then shake, mix, stir, or otherwise act to create a custom drink. Any number of chambers may be suitably provided that may be readily fit within, and externally accessible from the container, such as 8 chambers. 8 chambers may provide, for example, up to 40,320 possible combinations.

According to an aspect of the present invention, certain ingredients or constituents that are undesirable for a segment of the populations, such as artificial sweeteners for people who are pregnant, certain stimulants for professional athletes, for example, may thus be provided for use by some users, but may be selectively left unopened by other users within a chamber, which other users may be provided with more suitable constituents for selection instead.

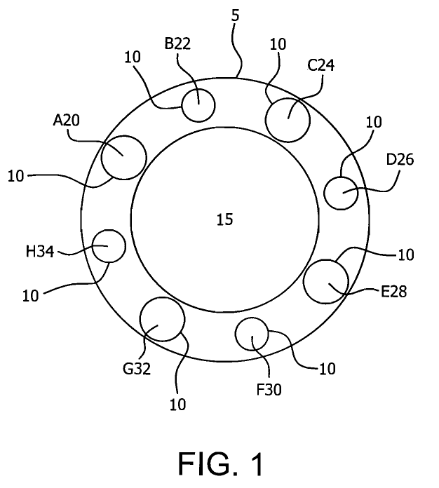

Referring now to FIG. 1, there is shown a cut away of a container according to an aspect of the present invention. As may be seen in FIG. 1, a set of compartments 10 may surround a center chamber 15 of the bottle 5. Set of compartments 10 may include any number of compartments. The exemplary embodiment shown in the picture includes eight compartments included in set of compartments 10. The eight compartments shown include compartment A 20, B 22, C 24, D 26, E 28, F 30, G 32, and H 34. Each of these individual compartments may have a methodology for breaking the compartment to thereby incorporate at least a portion of the contents of the compartment as constituents with the contents of the center chamber 15. These compartments may all be of substantially the same size and shape, or, such as to accommodate the quantities of constituents in the compartments to be added in, compartments may have two or more discrete sizes and shapes.

Container 5 may be made in the shape of a standard bottle, for example. Container 5 may be made from plastics, recycled plastics, aluminum, or other material, as would be evident to those possessing an ordinary skill in the pertinent arts, and may preferably be formed of a deformable substance that may allow pressure to be exerted against the compartments from a user-applied force external to the container. Container 5 may be sealed with a screw on cap (not shown), removable tab, flip top, or other mechanism to seal the contents of center chamber 15, and/or of the compartments, inside. Container 5 may also have incorporated therein protection from light sources, such as by darkening or opaqueing the bottle material, and may also be designed to reduce the effects on the contents of temperature change, such as that which may be experienced during shipping.

Set of compartments 10 may be made from a material similar to that of container 5. Compartments 10 may also share a common wall with center chamber 15, or be immersed within center chamber 15. Compartments 10 also may be accessible when the seal with a screw cap is opened. Compartments 10 may alternatively be formed of materials that are different from that of container 5, including formation of one or more substances that may dissolve over time in the presence of the elements in the center chamber, and/or of one or more substances that may dissolve in the presence of other elements, once released, such as those elements in other compartments.

Center chamber 15 may be a self-supporting compartment and share no common walls with compartments 10. Compartments 10 may also be sealed such that no direct access to compartments 10 may be achieved through normal operation. Set of compartments 10, like many bottles found in the art, may be made from materials which reduce or limit the environmental factors that the contents of the compartments may be placed under. This includes limiting the amount of light entering the compartments and may also include incorporating materials to minimize the effects temperatures may have on the contents.

The compartments 10 may include the individual components of a flavored beverage, for example. These compartments may be labeled or color coded so that the user may be able to identify the particulars of the compartment contents.

In an exemplary embodiment, as is known to those possessing a skill in the pertinent arts, vitamin water is generally composed of water, nutrients, flavor, and cocktails, for example. Other ingredients that may be either combined within a compartment or placed separately in a compartment include distilled water, crystalline fructose, citric acid, electrolytes, natural flavors and vitamins, including but not limited to, vitamin C, vitamin B3, vitamin B4, vitamin B5, vitamin B6, vitamin B12 and vitamin E, for example. Constituents may take the form of a solid, liquid or gas for combination with the ingredients of the center chamber.

In such a configuration, according to the present invention, the center chamber may be filled with the water necessary for the vitamin water; certain nutrients or cocktails may be included in ones of the compartments. For example, salt, taurine, magnesium and potassium may be included in one or more compartments, either individually or in solution, such that upon activation this compartment would combine with the water in the center chamber to produce the desired flavored beverage using the constituents in the selected compartment(s). Similarly, the various compartments may include sweeteners, such as one compartment including high fructose corn syrup and/or sugar, a second compartment including Equal®, and a third compartment including Sweet and Low®. Alternatively, the various sweeteners may include only one per bottle, such as wherein the myriad of different shelves in a vending machine are organized to provide sweetener and/or flavor options by selection of the product.

Once the center chamber and the surrounding compartments are filled with the requisite constituents, a mechanism to control the combination with that found in the center chamber in preparation for consumption may be provided. This selection mechanism may take the form of a key relationship, such that turning a mechanical item on the outside of the container may selectively open ones of the compartments, thereby combining the constituents therein with the center chamber ingredients. Additionally and alternatively, each compartment itself may have an individual key toggle. Further, the mechanism may be designed like that of a glow stick, in that selective pressure or depressing adjacent a compartment, may crack the compartment, thereby allowing the constituents to combine in the center chamber. Alternatively, the mechanism used may be a plunger type mechanism, such as with buttons near the cap to activate a plunger for each compartment. Conceptually similar to the select an ink color pen, this method may selectively activate ones of the compartments for combination with the center chamber.

Once the constituents are activated to be mixed with the ingredients of the center chamber, it may be necessary to shake, use a stirrer within or without the container, or provide other force to the product in order to facilitate appropriate mixing of all desired ingredients. The duration and amount of such external force may be proportional to the type of activation mechanism chosen and how easily the selected constituents are able to exit the activate compartments. Also, the force may be relative to the type of constituents that are included within the compartments, such as when less force is necessary if all the constituents are in a liquid form, as opposed to the incorporation of granular sugar, which is likely to require more shaking of the bottle to facilitate mixing.

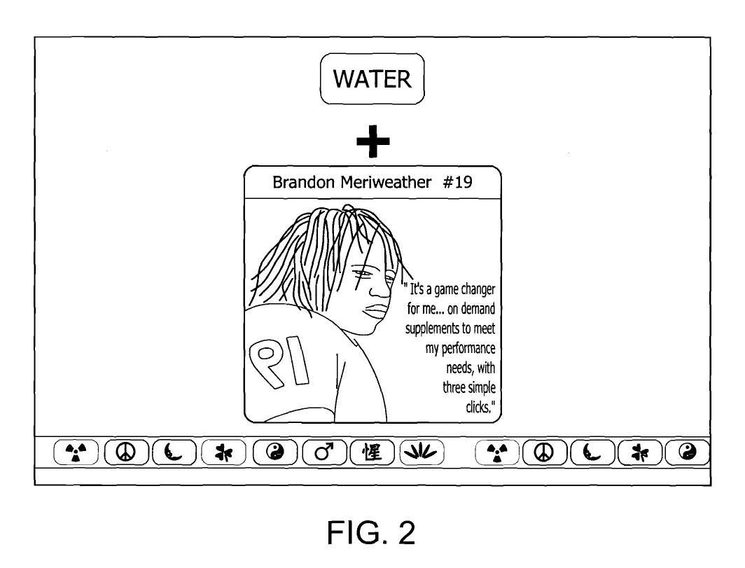

Referring now to FIG. 2, there is shown an endorsement for placement on a bottled drink according to an aspect of the present invention. This endorsement may take the form of a recommended flavor/supplement from a particular endorsing talent, or may be recommended as a favorite flavor/supplement of that endorsing talent. It may also take the form of an endorsing talent whose nickname relates to a beverage, such as “Juice” or “OJ,” for example. In such a situation, an orange juice product or orange juice flavored vitamin water may be endorsed by such a talent.

As may be seen in FIG. 2, there is shown a wrapper for placement on a bottle according to an aspect of the present invention. FIG. 2 shows that the beverage is endorsed by athlete Brandon Merriweather and includes water, plus the supplements Merriweather endorses using. In addition, there is the traditional supplement fact sheet identifying the vitamins/minerals, ingredients and blending that is contained in the drink. Additionally, a quote from the talent may be included. As may be seen in FIG. 2, the exemplary quote includes “It's a game changer for me . . . on demand supplements to meet my performance needs, with three simple clicks.” Also shown in FIG. 2 are logos and marking that may denote the specific supplements contained and/or available within the drink. It may be such that all possible supplements may be marked. These logos and/or indications of available constituents are shown across the bottom portion of the illustrated label. In this case, each of these logos may denote a particular supplement or ingredient.

It should be appreciated that, when labeling the multi-chamber beverage container as described herein, it may be desirable to have greater flexibility in selection of the endorsing talent when creating the label. For example, for a multi-chamber beverage container having eight secondary chambers as depicted in FIG. 1, wherein each secondary chamber holds a different constituent, the endorsing talent or talents may correspond to the particular constituents they recommend. In one embodiment, talents may recommend individual constituents. In other embodiments, talents may recommend certain constituent combinations. Thus, the present invention also provides a labeling system and engine for generating labeling indicia that integrates talents or endorsers commensurate with the products and constituents provided for a multi-chamber container.

The labeling engine may request or allow for the request of labeling materials or labeling information, such as a product endorser or talent. The engine, responsive to the request for the labeling materials or information, may query a material server to determine what talent matches the request. After determining a talent that matches the request, the server may deliver to the requesting party the materials or information that should be selectively placed in the label. This may occur by automated means, and the delivery may take the form of immediate delivery via an online server, for example. This delivery may also take the form of a server requesting delivery from a photo/labeling processor, such that the photo/labeling processor prints the materials and delivers for use in the label. The printing may include defining the final necessitated size required, or color schema, such as by selecting the appropriate talent for endorsement, as defined in the present invention.

The present invention may additionally include a networked, communicatively interconnected system and method of delivering labeling materials. According to an aspect of the present invention, a platform or engine may be provided to allow for the obtaining of labeling materials and/or information, including an endorsement, either from a specific individual, a specific entity, a brand, a marketing partner, or a sponsor, for example. The development of well targeted labeling materials involves a dynamic interrelationship between all relevant factors, such as, for example, the goods, the geographic market of the goods, the prospective purchasers, any endorsing personalities and their agents, and the existing or upcoming media associated with each. A labeling materials and information delivery engine thus may preferably harness and manage all aspects of each of these factors, based upon only a limited number of parameters from which to initiate and generate such labeling materials.

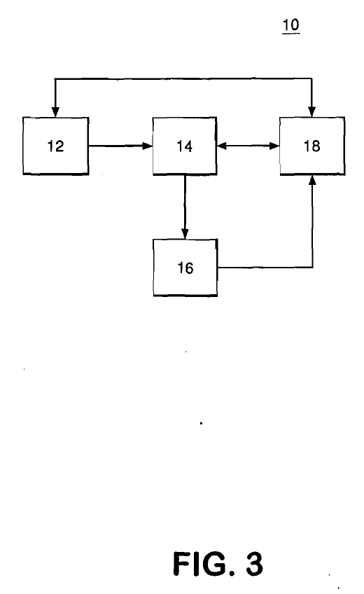

As illustrated in FIG. 3, a brand affinity software engine 10 of the present invention may provide a recommendation engine 12, a creative engine 14, a fulfillment engine 16, and a management engine 18. Those skilled in the art will appreciate that, although these engines are illustrated collectively in FIG. 3, that the present invention additionally contemplates the use of each of these engines discretely from the remaining illustrated engines. In this exemplary embodiment, the recommendation engine may, based on any number of known or assessed factors, recommend, for example, a specific endorser for a certain market or a sponsorship brand for use at certain times, in certain geographies, or with regard to certain products or services. The recommendation engine may generate recommendation metrics, and/or may issue scores, rankings, or the like. The creative engine may provide one or more templates for the creation of labeling materials, and may additionally provide content, such as from a content “vault” that includes content of a variety of media formats, a variety of existing materials, or to a myriad of sponsors, for inclusion in a label generated using such a template. For example, such content may have limited availability categorized by time, location, product, service, or the like. The fulfillment engine of the present invention, also referred to herein as the label materials server, may deliver labeling materials, such as from the creative engine. The management engine of the present invention also provides for tracking and reporting, as well as feedback for improved metrics and confirmations as discussed hereinabove, of the materials placed on labels using the present invention.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A labeling system for placement of at least a portion of a label on a multi-chamber beverage container, comprising:
a label materials engine for selection of a label for placement on the multi-chamber beverage container, the label comprising at least one talent for endorsing at least one of a first and a second beverage constituent within the multi-chamber beverage container; and
the multi-chamber beverage container comprising:
a first chamber that contains the first beverage constituent, and comprising at least one resealable opening for dispensing the beverage;
at least one secondary chamber that contains the at least one second beverage constituent, wherein the secondary chamber is physically adjacent to the first chamber, and wherein the secondary chamber and first chamber are separated by at least one initial seal;
wherein the at least one second beverage constituent is at least partially dissolved into the first beverage constituent upon an at least temporarily breaking of the at least one initial seal by a force applied by a consumer of the beverage;
wherein the at least one talent is selected responsive to selection of at least one of the first and the second beverage constituent, such that the talent at least partially endorses a beverage created by the dissolving of the at least one second constituent in the first beverage constituent.

2. The labeling system of claim 1, wherein the selection of the at least one talent is further based on a targeted geographic market of the multi-chamber beverage container.

3. The labeling system of claim 1, wherein the selection of the at least one talent is further based on targeted purchasers of the multi-chamber beverage container.

4. The labeling system of claim 1, wherein the selection of the at least one talent is further based on the recent existing media associated with the at least one talent.

5. The labeling system of claim 1, wherein the selection of the at least one talent is further based on prospective media associated with the at least one talent.

6. The labeling system of claim 1, wherein the at least one talent comprises an athlete.

7. The labeling system of claim 1, wherein the at least one talent comprises at least two talents, and wherein a first of the at least two talents endorses the first constituent, and a second of the at least two talents endorses the second constituent.

8. The labeling system of claim 1, wherein the talent endorses the second constituent, and wherein the second constituent comprises medication.

9. The labeling system of claim 1, wherein the resealable opening includes at least one selected from the group consisting of a screw-on cap, a tab and a flip-top.

10. The labeling system of claim 1, wherein the force is applied solely to an exterior of the multi-chamber container.

11. The labeling system of claim 10, wherein the initial seal is at least partially cracked by the force.

12. The labeling system of claim 10, wherein the force comprises a depression.

13. The labeling system of claim 1, further comprising a plunger mechanism that is activated by the force.

14. The labeling system of claim 1, wherein a mixing of the first and second beverage constituents is metered.

15. The labeling system of claim 14, wherein the metering is according to consumer preference.

16. The labeling system of claim 1, wherein the at least one talent comprises an actor.

17. The labeling system of claim 1, wherein the endorsement comprises a pre-approval within the labeling materials engine.

18. The labeling system of claim 1, wherein the endorsement comprises an approval interface within the labeling materials engine to the at least one talent.

19. The labeling system of claim 1, wherein the labeling materials engine comprises a recommendation engine that recommends ones of the talent.

20. A labeling system for placement of labeling information on at least a portion of a label of a multi-chamber container, comprising:
a label materials engine for selection of a label for placement on the multi-chamber container, the label comprising at least one talent for endorsing at least one constituent within the multi-chamber container; and
the multi-chamber container comprising:
a first chamber that contains a first constituent, and comprising at least one resealable opening for dispensing a constituent mixture;
at least one secondary chamber that contains at least one secondary constituent, wherein the secondary chamber is physically adjacent to the first chamber, and wherein the secondary chamber and first chamber are separated by an initial seal;
wherein the at least one secondary constituent is added to the first constituent upon an at least temporarily breaking of the initial seal by a force applied by a consumer of the multi-chamber container;
wherein the at least one talent is selected responsive to selection of at least one of the first or secondary constituents, such that the talent at least partially endorses the constituent mixture created by combining the at least one secondary constituent in the first constituent.
